(19) United States
(12) Patent Application Publication
(10) Pub. No.: US 2010/0258018 A1
(43) Pub. Date: Oct. 14, 2010

(54) Overprint stamp and method thereof

(76) Inventor: Long-Jer Chou, Taipei (TW)

Correspondence Address: LONG-JER CHOU, P.O. BOX 44-2049, Taipei, 10668, TW

(21) Appl. No.: 12/385,563

(22) Filed: Apr. 13, 2009

(51) Int. Cl. B41K 1/42

(52) U.S. Cl. 101/333

(57) ABSTRACT

In an overprint stamp and its method, mesh points are used to produce a pattern on a surface of the overprint stamp, such that the stamp has a function similar to a portable color printer. After inks of different colors have gone through an overprint process, the colors gone through the overprint process produce the effects of different colors and different layers to produce colors similar to a color photo.

### BACKGROUND OF THE INVENTION

(1) Field of the Invention

The present invention relates to a color stamp and its manufacturing method, in particular to a stamp using an overprint method to achieve color mixing and printing effects.

(2) Description of the Prior Art

In a conventional stamp, the color of a printed pattern depends on the color of an ink pressed onto the surface of the stamp. If one wants to obtain a pattern in different colors by using a stamping method, the only way is to obtain the corresponding color inks, and thus the basic tools required by a stamp craftsman to make creative stamps include inks and materials in various different colors. In addition, the ink of a normal stamp must be printed uniformly and clearly without any overlap. Even for master and slave stamps or a stamp set, no overlap is allowed in any portion of the pattern.

The so-called color stamp has a plurality of ink absorption areas with different and unmixed colors to produce different blocks of the pattern in different colors. In other words, the inks of different colors are coated directly onto the surface of the stamp to give a color effect to the stamped pattern. The inks of different colors are maintained clear and separated from each other, or the stamp with an adhesive is stamped at a desired position, and then a full-color decorative powder such as a glitter powder is sprinkled onto the adhesive to show the color effect. In summation, the colors of the foregoing stamps are different from what we know about colors traditionally. It also indicates that color stamps are in urgent needs.

In the aforementioned stamps, there is a stamp set which never has the overprint stamp mode, and the stamp set generally adopts a conventional technology to print a pattern in different colors with inks, but the printing effect is poor. The traditional way of making stamps is limited to the different kinds of inks, printing materials and patterns. However, it is very rare to find a good stamp overprint with a three-dimensional color effect among these traditional stamps.

### SUMMARY OF THE INVENTION

In view of the traditional stamps without an overprint function, it is not an issue of the ink, but an issue of the structure of the stamp. A vast majority of stamp patterns are composed of lines or surfaces. In the process of pressing or coating the ink onto the stamps each time, it is difficult to have a uniform coating of ink, and thus the result will be very complicated or unexpected if the stamp is pressed or coated with a different ink next time. Obviously, the traditional stamps are unable to achieve a color-harmonic effect.

In the printing industry, screen printing is an excellent technique for stamping a pattern. After any pattern is screen printed, small invisible points which are generally called “mesh points” are centralized to provide one to several times of spaces around each color mesh point, such that the inks of different colors can occupy the spaces to produce a color mixing and illusive effect.

1. It provides convenience and good feeling of carrying a color printing tool to allow users to stamp a favorite three-dimensional color pattern to a position including clothes, bags or even bodies anytime and anywhere.

2. It overcomes the issue of insufficient colors, and an overprint of different colors achieves the color-harmonic function, and several basic colors are required to produce different colors and both dark and light colors.

3. It helps those not so skillful to produce lively color patterns.

4. It solves the problem of requiring a large machine for color printing, and only a small stamp can produce an artwork up to the color publication level.

5. It expands the area of stamp artcrafts and allows stamps to enter into our daily life. Users can apply a personal color 3D stamp on documents, clothes, packages, objects, or even any part of their body. Card or business card manufacturers no longer require a special printing machine to produce personal color uniform, bags and stationeries, etc to achieve the effects of making our life full of fun, changing the color of our body without relying on tattoos, giving us a better health and a more beautiful world.

The main characteristic of the present invention resides on that a pattern used for manufacturing a stamp by a screen printing, regardless of a color pattern or a monochrome pattern, goes through a screen process, such that each color can be produced by different basic colors and mesh points of different sizes. Since each mesh point has some spaces around the periphery remained for adding other colors, and the dark and light layers of the pattern cannot be expressed, the tiny invisible mesh points with different sizes are used for making diversified harmonic colors by a limited number of ink colors through visual mixing and eye illusion, so as to eliminate the drawback of the non-uniform ink of the stamp, and modify the pattern pressed by the mesh points through the visual illusion to achieve the uniform color effect. Since each mesh point has a blank around the periphery, extra ink has a space for its diffusion.

In the printing industry, the main purpose of using screen photography is to provide the layers for continuous dark and light colors that cannot be expressed by the pattern. The main purpose of the screen process in accordance with the present invention is to reserve spaces for the inks of different colors, and visual illusion and visual mixing are used for visually harmonize the non-uniform colors of the inks with two or more colors or the partially overlapped inks.

The secondary characteristic of the present invention is to use an electronic color separation method to decompose the colors of a pattern into electronic signals of three or four basic colors, and the colors are modified and films are outputted by laser spots after the modification takes place. This is called a color separation film which simply requires inks in three to four basic colors. The dark color comes with large mesh points and small peripheral spaces. The light color comes with small mesh points and large peripheral spaces for providing a better chance for printing other color inks.

The major difference between the present invention and printing resides on that stamp is a natural free-style tool, and it is very difficult to control the composition of inks, the humidity of card paper, the pressing time and the overprint precision. For the printed inks, techniques such as humidification can be used to provide a better viscosity of the inks. The inks for the stamp are generally quick drying, and the card paper does not need humidification process, and thus it makes the printing feasible, even though the stamp art craft may not be feasible for printing. In a print-color sequence, black color is generally printed first, and then green and red are printed, and finally yellow is printed. However, the stamp art craft is different or even opposite. Yellow, red and green are printed and finally black is printed. Thus, the color printing has been used for years, but the color stamp still has not been developed yet.

The present invention provides an overprint stamp having one or more mesh points to show a stamp combination of color separation films, wherein a space is maintained between mesh points and used as a method of visually harmonize the color-separation stamp in different colors through an overprint to manufacture different colors and layers. Regardless of a monochrome photo or a color photo, each pattern can use the electronic color separation to show its color separation film by mesh points, and go through the traditional stamp manufacturing method of using a photosensitive resin plate, a silk screen or even a planographic print to manufacture different overprint color-separation stamps, and common standard coordinates are used for manufacturing different styled color patterns.

The unique feature of the present invention is to use a pattern of mesh points as an overprint stamp and an overprint stamp for harmonizing the colors of the inks for each stamp. The present invention totally changes the traditional concept that the inks of a stamp cannot be harmonized, or the stamp cannot do overprints. The invention further uses the overprint stamp for drawings and creating artworks. In addition to providing overprint color-separation stamps on the same surface pattern for overprinting a drawing closest to the original surface pattern, the invention also provides a tool similar to a drawing pen for creating wonderful artworks after the overprints of different overprint stamps take place.

### BRIEF DESCRIPTION OF THE DRAWINGS

FIG. 1 is a flow chart of manufacturing an overprint stamp by using mesh points in accordance with the present invention;

FIG. 2 shows an overprint stamp in accordance with a preferred embodiment of the present invention;

FIG. 3 shows an overprint stamp including four overprint color-separation stamps in accordance with the present invention;

FIG. 4 is a schematic view of using an overprint, a set square and a stamp fixing base;

FIG. 5 is a schematic view of combining each overprint color-separation stamp;

FIG. 6 is a schematic view of an overprint after colors are combined as depicted in FIG. 2;

FIG. 7 is a schematic view of each mesh point of an overprint color-separation stamp during an overprint process;

FIG. 7A shows a Y mesh point 1 of an overprint color-separation stamp;

FIG. 7B shows an M mesh point 2 of an overprint color-separation stamp;

FIG. 7C shows a C mesh point 3 of an overprint color-separation stamp;

FIG. 7D shows an overprint of M and C mesh points of an overprint color-separation stamp;

FIG. 7E shows an overprint of Y and C mesh points of an overprint color-separation stamp;

FIG. 7F is an overprint of Y, M, C mesh points of an overprint color-separation stamp; and

FIG. 8 is a schematic view of positioning an overprint stamp in accordance with a preferred embodiment of the present invention.

### DETAILED DESCRIPTION OF THE PREFERRED EMBODIMENTS

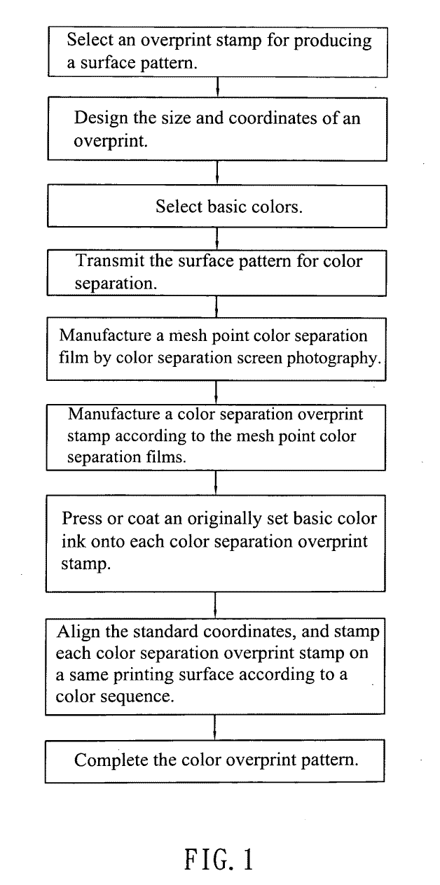

With reference to FIG. 1 for a flow chart of manufacturing an overprint stamp by using mesh points in accordance with the present invention, a surface pattern in any color can be used for manufacturing an overprint stamp and selected for making an overprint stamp of a specific color. After the surface pattern of a stamp and the basic color of an overprint stamp have been selected, the stamp is transparent, since many stamps are made of a transparent material. For opaque stamps, a positioning ruler, a ruler or a frame line are used as a reference line for the overprint of each overprint color-separation stamp having the same shape and the same size, and thus making the overprint very convenient.

The present invention includes important tasks such as the electronic color separation of the surface pattern and the screen photography for manufacturing color separation film surface patterns of overprint stamps in different colors, and each mesh point color separation film is manufactured into a color-separation overprint stamp in different colors by using conventional stamp manufacturing techniques. Users simply coat or press ink in each originally designed color onto each overprint stamp or inks of different colors, and perform an overprint onto the same block or the same position of a desired object. Although the inks used for stamping are different, a color harmonic effect can be produced. The main purposes of color separation and screening are to decompose surface pattern of different colors. More importantly, many tiny mesh points are produced, and an appropriate blank space is reserved around the periphery of each mesh point, such that the light and dark layers of colors can be produced even if the viscosity of the ink is poor, or the pressed block is not humidified, or the ink has a too-strong or too-weak coverability, such that the same ink can be used for producing deep, shallow, dark and light layers of colors through the different sizes of mesh points. The invention further provides spaces of filling in overprint inks for the second, third or even fourth time.

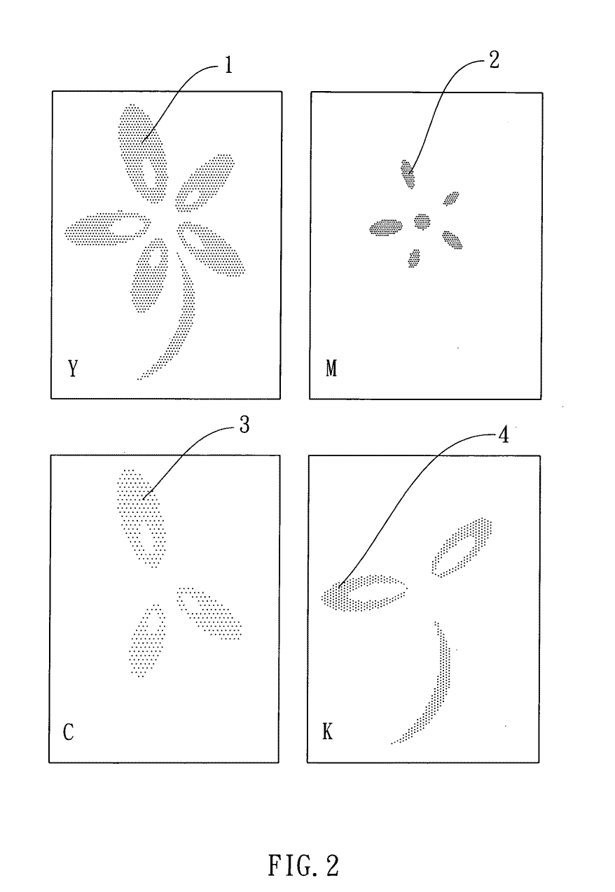

With reference to FIG. 2 for an overprint stamp containing four overprint color-separation stamps, the four overprint color-separation stamps are a yellow overprint color-separation stamp Y, a red overprint color-separation stamp M, a green overprint color-separation stamp C, and a black overprint color-separation stamp K. The different colored mesh points are represented by the following numerals: 1 for yellow mesh points, 2 for red mesh points, 3 for green mesh points, and 4 for black mesh points.

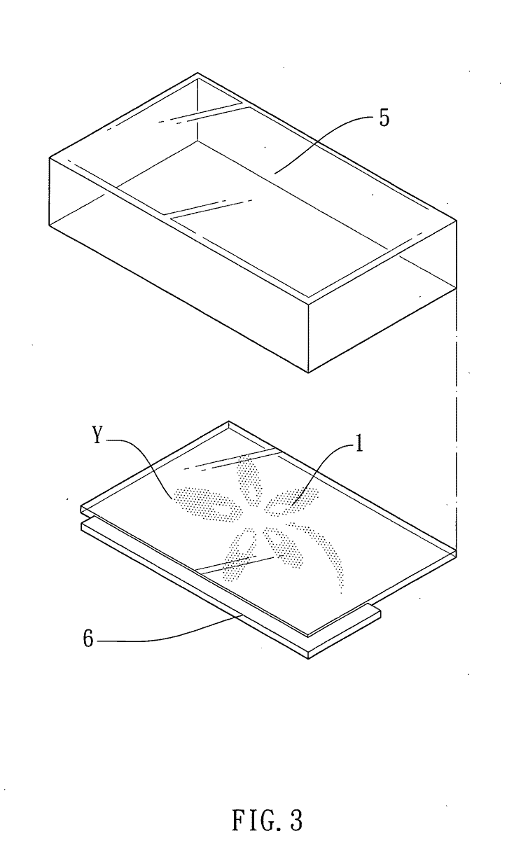

With reference to FIG. 3 for using an overprint stamp Y, a set square 6 and a stamp fixing base 5, an overprint color-separation stamp Y is used for confirming the stamping position when a first overprint color-separation stamp is used, and then the set square 6 is used to align a corner of the overprint stamp, such that the set square 6 is fixed, and the overprint color-separation stamps are changed to complete the overprint process. Alternately, the set square is fixed into a position, and then the overprint color-separation stamp of each color in a color sequence is pressed against the set square 6 to complete the overprint process. Static charges may be attached onto the stamp fixing base 5 to facilitate users to hold the stamp before pressing the overprint stamp Y or facilitate user to press the stamp Y. Basically, the overprint color-separation stamp can be fixed into its position easily for an alignment of the stamp during the overprint process, even if the set square 6 is not positioned or aligned with the edges.

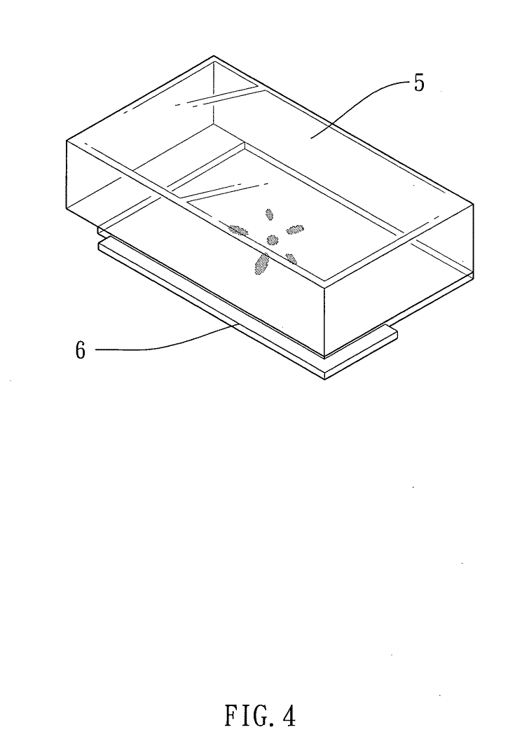

With reference to FIG. 4 for an overprint of the present invention, each overprint color-separation stamp is positioned by the set square 6 without being affected by the overprint position of each overprint color-separation stamp, even if the size of the stamp fixing base is not equal to the frame size of the overprint stamp.

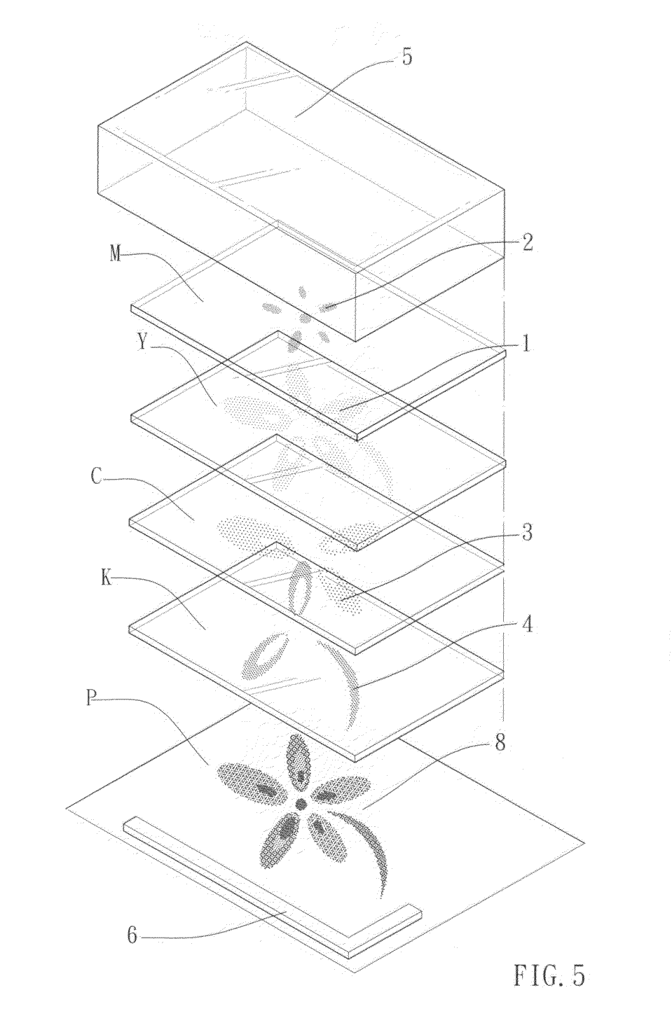

With reference to FIG. 5 for combining each overprint color-separation stamp, art is very unique, although each overprint color-separation stamp produces each color-separation surface pattern by the electronic color separation, and thus an overprint color-separation stamp of different surface patterns can provide different patterns and one of the different layouts of the mesh points, and the color arrangement is not unique. This is exactly the interesting and meaningful point of the present invention, so that users can use a different combination or permutation of colors anytime to stamp and produce a pattern in different colors.

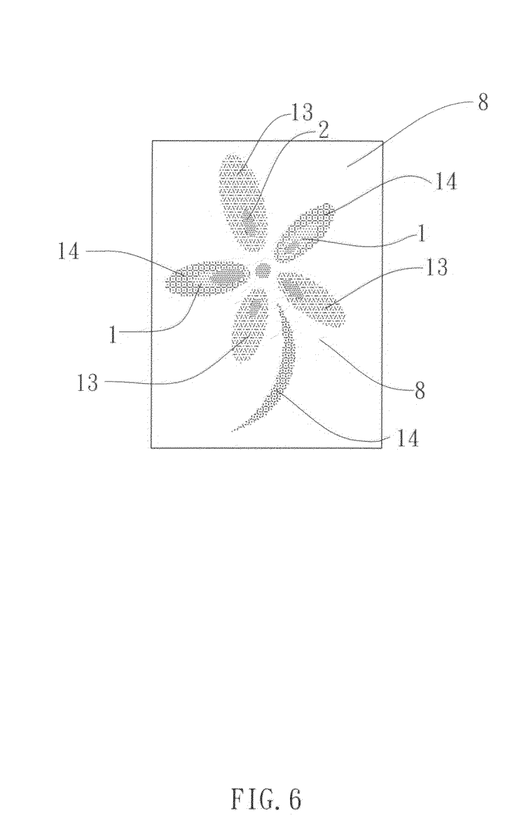

With reference to FIG. 6 for a schematic view of an overprint after colors are combined as depicted in FIG. 2, a numeral 14 is used for representing the color of overprinting yellow mesh points 1 and black mesh points 4. The visual harmony and illusion originated from the periphery of each mesh point produce a middle harmonic effect of the color 14. The same also applies to a numeral 13, wherein the overprint of yellow mesh points 1 and green mesh points 3 produces a middle harmonic effect of the color 13.

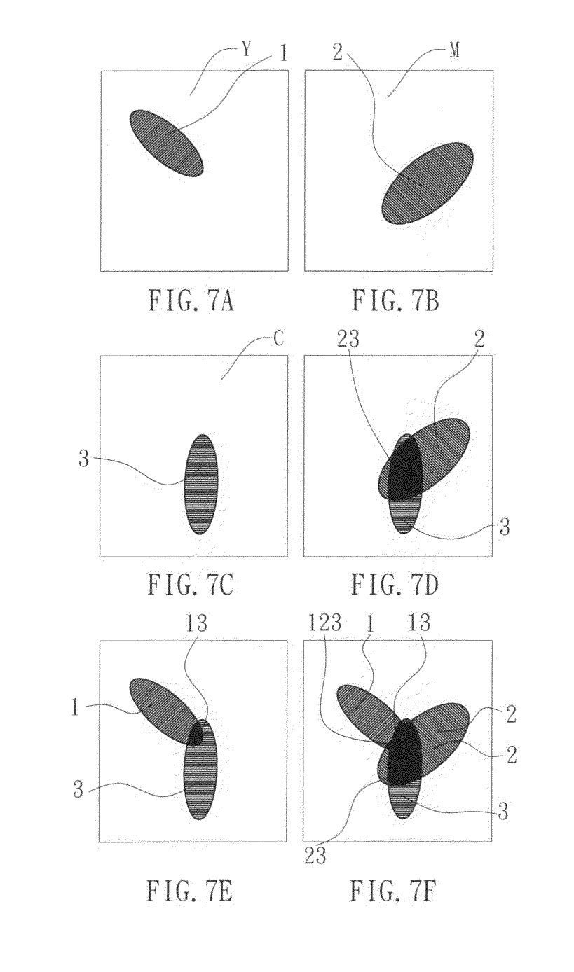

With reference to FIG. 7 for a schematic view of each mesh point of an overprint color-separation stamp during an overprint process, FIG. 7A shows an overprint color-separation stamp A containing a small mesh point 1, assumed that it is a yellow overprint stamp; FIG. 7B shows an overprint color-separation stamp B containing a small mesh point 2, assumed that it is a red overprint stamp; FIG. 7C shows an overprint color-separation stamp C containing a small mesh point 3, assumed that it is a green overprint stamp. If the overprint color-separation stamp B as shown in FIG. 7B and the overprint color-separation stamp C as shown in 2C are skillfully overprinted on the same block as shown in FIG. 7D, three color blocks other than the blank space are produced, wherein the color 23 is produced when the red 2 is overlapped with the green 3. This color 23 is not purplish red, greenish purple or black, due to different natures of the inks. With the existence of red 2 and green 3, the visual illusion and the visual mixing plus many mesh points produce an intermediate vision such as the purple color. If the overprint color-separation stamp A as shown in FIG. 7A and the overprint color-separation stamp C as shown in FIG. 2C have a very small overprint portion unskillfully overprinted on the same block as shown in FIG. 7E, and thus fuzzy dark tiny mesh points will be produced to give rise to a better quality of visual harmony. The overprint color-separation stamps A, B, C as shown in FIGS. 7A, 7B and 7C are skillfully overprinted on the same block as shown in FIG. 7F, the colors other than the blank space becomes more complicated. Since each overprint stamp A, overprint stamp B, or overprint stamp C keeps a sufficient space, the ink pressed at each mesh point will not diffuse, and the ink at each mesh point will be uniform, so as to produce the color layer effect. It is the main reason why there was no overprint stamp in the past hundred or thousand years of the stamp history.

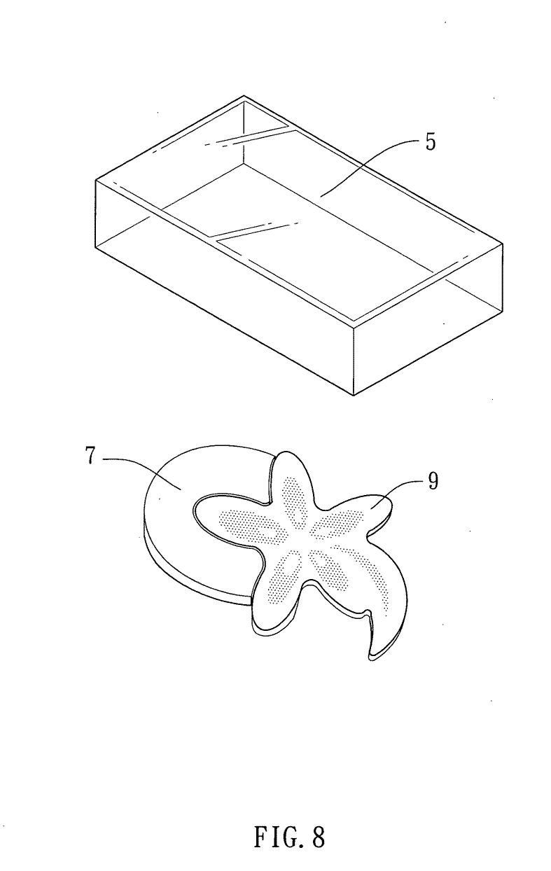

With reference to FIG. 8 for another preferred embodiment of an overprint stamp, this embodiment provides a fixed guide for overprinting each overprint stamp in a different shape. A traditional stamp always gives us an impression of a regular square shape, but the common stamps, particularly the art craft stamps 9 available in the market no longer come with a square shape based on the requirement of sheathing a stamp with another stamp and the consideration of the material cost. Most of the unnecessary spaces other than the surface pattern are removed, so that the space of the stamp can be minimized, and the material of the stamp can be minimized as well. As a result, the positioning device 7 can act as the best positioning tool for aligning a portion of the shape of the stamp for the overprint process, and each overprint can fall within the allowable range to achieve the overprint effect with visual illusions and harmony.

Another interesting point of the present invention is that each overprint color-separation stamp is pressed with different or uniform forces and the ink pad is not even uniform at each corner, so that some of the inks are overlapped, and the visual illusion, the visual harmony, and the precision tolerance of each overprint color-separation stamp overprint may have a slight difference, and such difference gives rise to diversified changes, and the ink of each color is coated with different forces and consumptions and a different pressing method. Therefore, each pressing point is different, and thus creating the biggest difference between the present invention and printing, and the most interesting point of the present invention. Users can change the printing sequence or the color sequence according to the personal preference to give more fun.

While the invention has been described by means of specific embodiments, numerous modifications and variations could be made thereto by those skilled in the art without departing from the scope and spirit of the invention set forth in the claims. In summation of the description above, the present invention improves over the prior art, and complies with the patent application requirements, and thus is duly file for patent application.

What is claimed is:

1. An overprint stamp, being an overprint color-separation stamp and comprising a pattern composed of one or more mesh points with a same shape, a same peripheral size, and a same surface pattern design.

2. The overprint stamp as claimed in claim 1, wherein the mesh points of the pattern come from the same surface pattern and go through a color separation film for an electronic color separation, and the mesh points are produced by a screen photographic method.

3. The overprint stamp as claimed in claim 1, wherein the mesh points of the pattern come from different surface patterns, and have the same shape and size, and the mesh points are used for producing an overprint with a unique creative concept and designing a special creative effect.

4. The overprint stamp as claimed in claim 1, further comprising a positioning tool corresponding to a portion of the periphery of the overprint color-separation stamp in addition to the one or more overprint color-separation stamps.

5. The overprint stamp as claimed in claim 1, wherein the positioning tool is a set square for providing a basis of positioning a right-angled overprint color-separation stamp.

6. The overprint stamp as claimed in claim 1, wherein the positioning tool is a positioning device designed according to a partial frame of the overprint color-separation stamp and provided for positioning the overprint color-separation stamp.

7. An overprint stamp manufacturing method, comprising a screen photographic method of manufacturing a color surface pattern of an overprint stamp into a plurality of mesh point surface patterns designed by different mesh points, and manufacturing the mesh point surface patterns into a plurality of overprint color-separation stamps with a same shape and a same size, such that the overprint stamps in an overprint process maintain an ink stamping space from each other to provide an overprint effect of a visual illusion and a visual harmony.

8. The manufacturing method of an overprint stamp as claimed in claim 7, wherein the color surface pattern goes through an electronic color separation, and is decomposed into a color-separation surface pattern with a predetermined number of colors.

9. The manufacturing method of an overprint stamp as claimed in claim 7, wherein the overprint color-separation stamp having the same shape and the same size achieves an overprint effect by using different positioning tools to press the overprint color-separation stamp on the same block.
